(19) United States
(12) Patent Application Publication
(10) Pub. No.: US 2024/0346436 A1
(43) Pub. Date: Oct. 17, 2024

(54) Housing Network

(71) Applicant: Rongtian Xu, Kuala Lumpur (MY)

(72) Inventor: Rongtian Xu, Kuala Lumpur (MY)

(21) Appl. No.: 18/300,265

(22) Filed: Apr. 13, 2023

(51) Int. Cl. G06Q 10/087; G06Q 50/08; G06Q 50/16

(52) U.S. Cl. CPC G06Q 10/087; G06Q 50/08; G06Q 50/163; G06Q 50/165

(57) ABSTRACT

A housing network for the manufacture and relocation of houses. The network establishes communities and showrooms. The houses are prefabricated and delivered to a community. The houses may be relocated within a community or to a different community. The houses include standardized connections for utilities. The network includes showrooms, where customers can purchase and customize their homes.

### FIELD OF THE INVENTION

The present invention relates generally to housing. The present invention relates more specifically to networks for manufacture, purchase, service, and relocation of houses.

### BACKGROUND OF THE INVENTION

Housing units have traditionally been considered a fixed asset. Home ownership is a part of many people's aspirations. The dream of home ownership leads to staying in a single location, because the home is considered fixed to a single location. This housing model has limited the homeowner's pursuit of a better quality of life, limiting their choice of living location and work based on the location of the house. The fixed housing asset can become a burden on the homeowner, requiring a cumbersome and costly process to sell a home and buy a new home to move to a new location.

It is an objective of the present invention to provide a housing solution that is a mobile asset. The present invention provides a means to relocate the home as needed.

### SUMMARY OF THE INVENTION

A housing network for the manufacture and relocation of houses. The network establishes communities and showrooms. The houses are prefabricated and delivered to a community. The houses may be relocated within a community or to a different community. The houses include standardized connections for utilities. The network includes showrooms, where customers can purchase and customize their homes.

### BRIEF DESCRIPTION OF THE DRAWINGS

FIG. 1 is a flowchart of the present invention.

FIG. 2 is a flowchart of the present invention.

FIG. 3 is a flowchart of the present invention.

FIG. 4 is a flowchart of the present invention.

### DETAILED DESCRIPTION OF THE INVENTION

All illustrations of the drawings are for the purpose of describing selected versions of the present invention and are not intended to limit the scope of the present invention.

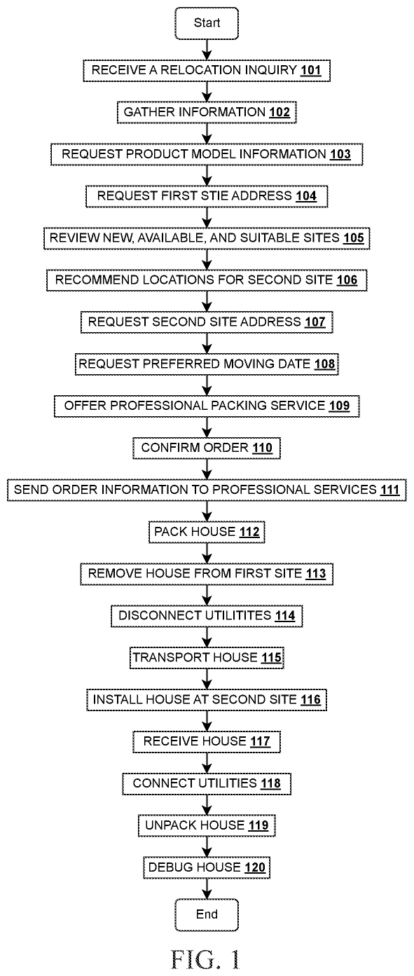

The present invention provides a chain of housing networks. The present invention allows the house to move with a person everywhere, rather than trapping the person in one place with the house. This housing network is formed through three main elements, namely manufacturing and production, commercial development and operation, and actual site application. Referring to FIG. 1, the present invention comprises a housing network for the manufacture and relocation of houses, the creation of communities of houses, and the establishment of showrooms. At step 101, the housing network receives an inquiry regarding relocation of a house. The network may receive the inquiry through a website, over the phone, or in-person. At step 102, the housing network begins gathering additional information. At step 103, the network requests the product model information of the house to be moved. At step 104, the network requests the address of the first site. For example, the network may request the current address of the house. At step 105, the network reviews new, available, and suitable sites for the second site. At step 106, the network makes a recommendation for the second site. For example, the network may recommend a destination location for the house. Alternatively, the client may suggest a preferred destination location. At step 107, the network requests the address for the second site. For example, the network may ask the homeowner to select a destination from the recommended destination locations. At step 108, the network requests a preferred moving date for the house. At step 109, the network offers additional professional services to aid with the move. For example, the network may recommend professional packing services. At step 110, the network confirms the order. Optionally, the network may present the details of the order to the homeowner and receive final approval from the homeowner. At step 111, the order information is sent to any professional services that were selected. At step 112, the network packs the house. For example, built-in furniture is secured to avoid damage during transport. At step 113, the network begins removing the house from the first site. At step 114, the network disconnects the utilities from the house. At step 115, the network transports the house from the first site to the second site. At step 116, the network begins installing the house at the second site. At step 117, the network receives the house at the second site. At step 118, the network connects the utilities to the house. At step 119, the network unpacks the house. At step 120, the network debugs the house. For example, the network may test that electricity and water are functioning in the house. The network may test for errors that occurred during installation of the house.

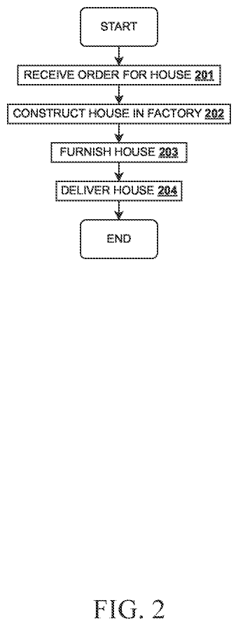

Referring to FIG. 2, the housing network receives an order for a new house at step 201. At step 202, the network constructs the house in a factory. For example, the network prefabricates the exterior and interior of the house. At step 203, the network furnishes the house. For example, built-in tables and seats are installed inside the house. The built-in furniture allows the house to be relocated without damaging the furniture. At step 204. the network delivers the house. The house is transported to the desired lot, the house is installed on the lot, and the utilities are connected.

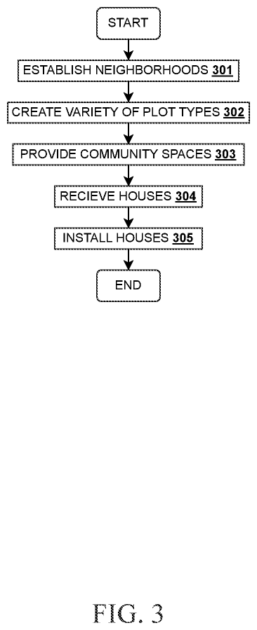

Referring to FIG. 3, the housing network establishes neighborhoods at step 301. At step 302, the network creates a variety of plot types inside each neighborhood. For example, the plots will provide areas for residents to live, play, and work. At step 303, the network provides community spaces. At step 304, the network receives houses at the neighborhoods. At step 305, the network installs the houses onto plots within the neighborhoods.

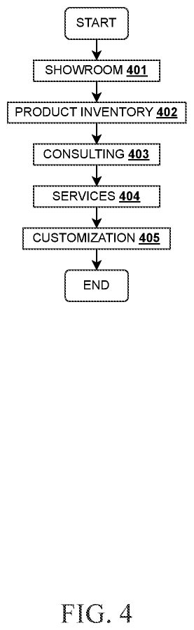

Referring to FIG. 4, the housing network establishes showrooms at step 401. At step 402, the network displays product inventory at the showroom. At step 403, the network provides consulting to customers and potential customers. At step 404, the network provides additional after-sale services to customers. At step 405, the network aids customers in customizing their house. For example, the customer may customize the exterior, interior, or furniture of the house.

Although the invention has been explained in relation to its preferred embodiment, it is to be understood that many other possible modifications and variations can be made without departing from the spirit and scope of the invention as hereinafter claimed. It is to be understood that the steps may be performed in any order, and steps may be repeated or omitted without departing from the spirit and scope of the invention.

What is claimed is:

1. A method for a housing network comprising:
receiving a relocation inquiry corresponding to a house;
removing the house from a first site;
transporting the house to a second site; and
installing the house at the second site.

2. The method for a housing network of claim 1, wherein receiving the relocation inquiry further comprises:
receiving model information of the house;
receiving a current address of the house;
receiving a destination address of the house; and
receiving a moving date of the house.

3. The method for a housing network of claim 1, wherein receiving the relocation inquiry further comprises offering professional packing services.

4. The method for a housing network of claim 1, wherein receiving the relocation inquiry further comprises recommending locations for the second site.

5. The method for a housing network of claim 4, wherein recommending locations for the second site further comprises:
reviewing newly constructed sites;
reviewing available sites; and
reviewing suitable sites.

6. The method for a housing network of claim 1, further comprising:
creating an order based on the relocation inquiry;
confirming the order; and
sending selected services to one or more professional service providers.

7. The method for a housing network of claim 1, wherein removing the house from the first site further comprises:
packing an interior of the house;
disconnecting one or more utility connections from the house.

8. The method for a housing network of claim 1, wherein installing the house at the second site further comprises:
receiving the house
installing one or more utility connections to the house;
unpacking an interior of the house; and
debugging the house for one or more installation errors.

9. A method for a housing network comprising:
receiving an order for a house
constructing the house; and
delivering the house.

10. The method for a housing network of claim 9, wherein receiving the order for the house further comprises receiving customization options selected by a customer.

11. The method for a housing network of claim 9, wherein constructing the house further comprises prefabricating the house in a factory.

12. The method for a housing network of claim 9, wherein constructing the house further comprises constructing one or more furniture pieces.

13. A method for a housing network comprising:
constructing a plurality of modular lots;
installing utility connections on each modular lot of the plurality of modular lots.

14. The method for a housing network of claim 13, further comprises receiving a house.

15. The method for a housing network of claim 14, further comprising installing the house at a destination plot.

16. The method for a housing network of claim 13, further comprising reserving one or more lots.

17. The method for a housing network of claim 13, further comprising establishing one or more community spaces.
